(19) United States
(12) Patent Application Publication
(10) Pub. No.: US 2009/0236848 A1
(43) Pub. Date: Sep. 24, 2009

(54) Bidirectional pipe grip sleeve

(76) Inventors: Keith G. Foreman, Hummelstown, PA (US); Scott J. Lenker, Grantville, PA (US); Craig R. Wallace, Hummelstown, PA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/382,558

(22) Filed: Mar. 18, 2009

Related U.S. Application Data
(60) Provisional application No. 61/064,682, filed on Mar. 19, 2008.

(51) Int. Cl. F16L 3/00

(52) U.S. Cl. 285/64

(57) ABSTRACT

The bidirectional pipe grip sleeve is a tubular sleeve for surrounding and supporting a conduit therein. The sleeve is adapted to be inserted through a pre-drilled opening in a barrier, such as a wall or floor. The sleeve has a tubular body with an outwardly extending annular flange at one end of the body, the sleeve defining a bore. The flange defines elongated, arc-shaped slots between the tubular body and the periphery of the flange for optionally receiving at least one fastener to fix the sleeve to the barrier during installation. A plurality of legs, having outwardly extending latches, extend from the end the tubular body opposite the flange for locking the sleeve to the barrier. A plurality of ribs are disposed in the bore and on the legs for frictionally gripping the conduit. Both ends of the sleeve are chamfered.

### CROSS-REFERENCE TO RELATED APPLICATION

This application claims the benefit of U.S. Provisional Patent Application Ser. No. 61/064,682, filed Mar. 19, 2008.

### BACKGROUND OF THE INVENTION

1. Field of the Invention

The present invention generally relates to a feed-through for supporting conduits and pipes passing through walls, floors, joists, and other structural members. More specifically, the present invention relates to a bidirectional pipe grip sleeve for supporting and securing a conduit as it passes through a wall or floor opening.

2. Description of the Related Art

Conventional building construction techniques often require that conduits (electrical, plumbing, etc.) pass through barriers, such as walls or floors. It is desirable that the conduits be firmly secured in the barriers to militate against future damage due to conduit movement as the building ages. Such damage usually requires expensive and time-consuming repairs. Further, electrical and plumbing conduits are subject to vibration, which may cause the conduit wall or the opening in the wall or floor to deteriorate over an extended period of time, or to produce rattling noises. It is also desirable to provide electrical and/or thermal insulation between the conduit and the opening through the building's structural member. The construction industry would certainly welcome a simplistic locking structure that can be employed to effectively secure conduits that are directed through barriers. Thus, a bidirectional pipe grip sleeve solving the aforementioned problems is desired.

### SUMMARY OF THE INVENTION

The bidirectional pipe grip sleeve is a tubular sleeve for surrounding and supporting a conduit therein. The sleeve is adapted to be inserted through a pre-drilled opening in a barrier, such as a wall or floor. The sleeve has a tubular body with an outwardly extending annular flange at one end of the body, the sleeve defining a bore. The flange defines elongated, arc-shaped slots between the tubular body and the periphery of the flange for optionally receiving at least one fastener to fix the sleeve to the barrier during installation. A plurality of legs, having outwardly extending latches, extend from the end the tubular body opposite the flange for locking the sleeve to the barrier. A plurality of ribs are disposed in the bore and on the legs for frictionally gripping the conduit. Both ends of the sleeve are chamfered to allow for easy insertion of the conduit from the flange end and to permit adjustment of the conduit from either end of the sleeve.

The sleeve may be made as a unitary component from a flame-retardant, thermoplastic material and produced through an injection molding process.

Accordingly, the invention presents a bidirectional conduit grip sleeve that is of one-piece design and that permits a conduit to be adequately secured through barriers of a thickness up to one inch. Application of the sleeve saves time and the need for additional labor in the installation of new plumbing for both commercial and residential construction, thus reducing costs. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is a perspective view of a bidirectional pipe grip sleeve according to the present invention as seen from the flange.

FIG. 2 is a perspective of a bidirectional pipe grip sleeve according to the present invention as seen from the end opposite the flange.

FIG. 3 is an environmental side view in section of a bidirectional pipe grip sleeve according to the present invention, showing installation of the sleeve through a floor or other barrier.

Similar reference characters denote corresponding features consistently throughout the attached drawings.

### DETAILED DESCRIPTION OF THE PREFERRED EMBODIMENTS

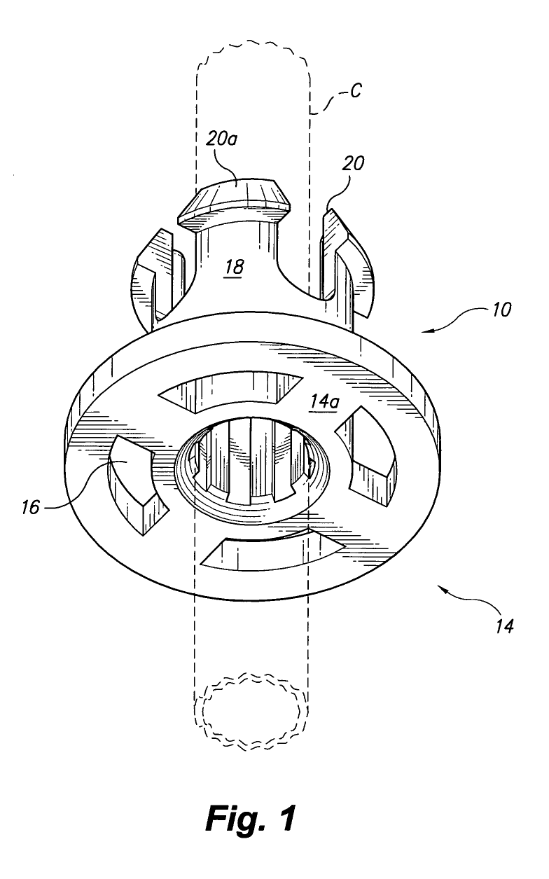

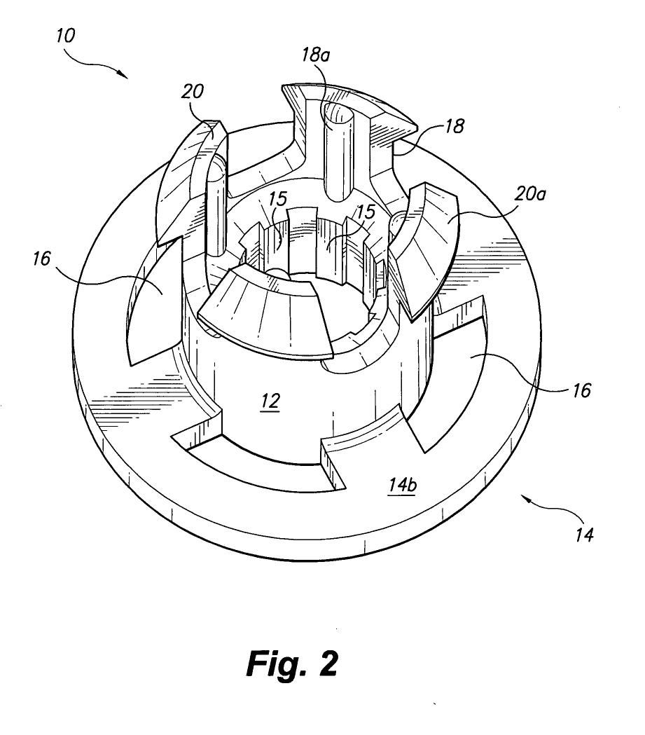

Attention is directed to FIGS. 1-3, wherein the bidirectional pipe grip sleeve is generally indicated at 10. Sleeve 10 comprises a hollow, tubular body 12 terminating at one end in an annular flange 14. The flange 14 is a flat disk with planar top and bottom surfaces 14a, 14b. Flange 14 defines a plurality of elongated, arc-shaped slots 16 therethrough, which are evenly spaced around the periphery of the flange 14 and concentric with the bore of the tubular body. The slots 16 extend between the tubular body 12 and the periphery of the flange 14. The tubular body 12 defines a bore dimensioned and configured for passing a pipe or conduit therethrough. A plurality of projecting ribs 15 are evenly spaced around the inner surface of tubular body 12, extending into the bore.

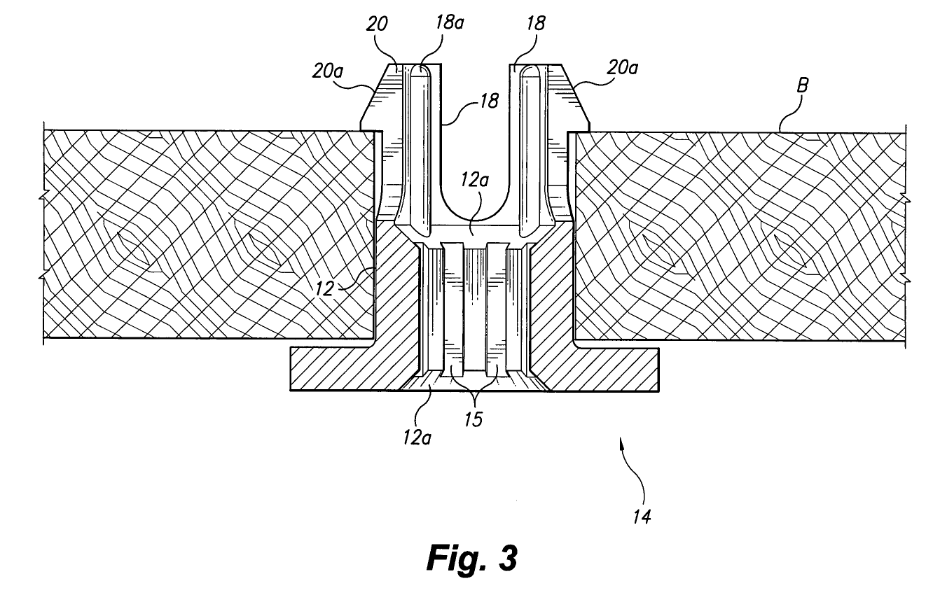

As shown in FIG. 3, each end of body 12 is chamfered at 12a for reasons explained below. A plurality of legs 18 is evenly spaced around and extend from the second end of tubular body 12, opposite the flange 14. Each leg 18 is fabricated from flexible, spring-biased or resilient, memory-retaining material. Each leg 18 terminates in a locking latch or lug 20. Each lug 20 projects outwardly from the outer surface of each leg 18 and is provided with a sloping guide surface 20a configured as a truncated cone. Each leg 18 is provided, on its inner surface, with a rib 18a that projects into the bore.

In use, sleeve 20 is inserted through a pre-formed opening through a barrier B, such as a wall or floor. The flexibility of legs 18 and the sloping surfaces 20a on locking lugs 20 allow the sleeve to be easily inserted through the opening. After insertion, legs 18 will bias outwardly, allowing lugs 20 to lock onto the surface of barrier B. A fastener (nail, screw, etc.) is optionally inserted through at least one of the openings 16 in flange 14 to retain the sleeve 10 in the barrier B. Chamfered ends 12a permit a conduit C (FIG. 1) to be inserted from the flange end and adjusted from either end of the sleeve 10. Ribs 15 and 18a frictionally secure conduit C in sleeve 10.

It is to be understood that the present invention is not limited to the embodiment described above, but encompasses any and all embodiments within the scope of the following claims.

We claim:

1. A bidirectional pipe grip sleeve, comprising:
a hollow body defining a bore dimensioned and configured for passing a pipe therethrough, the hollow body having an inner surface, a first end and a second end;
a flange disposed at the first end of the hollow body, the flange having a periphery and defining a plurality of elongated, arcuate slots extending between the hollow body and the periphery of the flange;
a plurality of legs extending from the second end of the hollow body; and
a locking lug disposed on each of the legs, respectively.

2. The bidirectional pipe grip sleeve according to claim 1, wherein said legs are fabricated from a flexible, resilient material.

3. The bidirectional pipe grip sleeve according to claim 1, wherein the first end and the second end of said hollow body are chamfered.

4. The bidirectional pipe grip sleeve according to claim 1, wherein each said locking lug has an outer, sloping surface.

5. The bidirectional pipe grip sleeve according to claim 1, wherein said arcuate slots are evenly spaced around the periphery of said flange.

6. The bidirectional pipe grip sleeve according to claim 1, further including a plurality of ribs disposed on the inner surface of said hollow body.

7. The bidirectional pipe grip sleeve according to claim 1, wherein each said leg has an inner surface and a rib disposed on the inner surface, the rib extending into the bore.

8. The bidirectional pipe grip sleeve according to claim 1, wherein said sleeve is of one-piece design and is fabricated from a flame-retardant, thermoplastic material.

9. A bidirectional pipe grip sleeve, comprising:
a hollow body defining a bore dimensioned and configured for passing a pipe therethrough, the hollow body having an inner surface, a first end and a second end;
a flange disposed at the first end of the hollow body, the flange having a periphery and defining a plurality of elongated, arcuate slots extending between the hollow body and the periphery of the flange, the arcuate slots being evenly spaced around the periphery;
a plurality of legs extending from the second end of the hollow body, lo the legs being fabricated from a flexible, resilient material; and
a locking lug disposed on each of the legs, respectively.

10. The bidirectional pipe grip sleeve according to claim 9, wherein the first end and the second end of said hollow body are chamfered.

11. The bidirectional pipe grip sleeve according to claim 9, wherein each said locking lug has an outer, sloping surface.

12. The bidirectional pipe grip sleeve according to claim 9, further including a plurality of ribs disposed on the inner surface of said hollow body.

13. The bidirectional pipe grip sleeve according to claim 9, wherein each said leg has an inner surface and a rib disposed on the inner surface.

14. The bidirectional pipe grip sleeve according to claim 9, wherein said sleeve is of one-piece design and is fabricated from a flame-retardant, thermoplastic material.

15. A bidirectional pipe grip sleeve, comprising:
a hollow body defining a bore dimensioned and configured for passing a pipe therethrough, the hollow body having an inner surface, a chamfered first end and a chamfered second end;
a plurality of ribs disposed on the inner surface of the hollow body;
a flange disposed at the first end of the hollow body, the flange having a periphery and defining a plurality of elongated, arcuate slots extending between the hollow body and the periphery of the flange, the arcuate slots being evenly spaced around the periphery;
a plurality of legs extending from the second end of the hollow body, the being fabricated from a flexible, resilient material; and
a locking lug disposed on each of the legs, respectively, each of the locking lugs having a sloping outer surface.

16. The bidirectional pipe grip sleeve according to claim 15, wherein each said leg has an inner surface and a rib disposed on the inner surface.

17. The bidirectional pipe grip sleeve according to claim 16, wherein said sleeve is of one-piece design and is fabricated from a flame-retardant, thermoplastic material.
